(19) United States
(12) Patent Application Publication
(10) Pub. No.: US 2002/0023092 A1
(43) Pub. Date: Feb. 21, 2002

(54) Information delivery system, information delivery apparatus, receiver apparatus, and information delivery method

(76) Inventors: Yoshihiro Tamura, Kanagawa (JP); Masanori Ishigaki, Kanagawa (JP); Tetsuya Narita, Kanagawa (JP); Takatoshi Kato, Tokyo (JP); Tsuguyo Goto, Kanagawa (JP); Kuniko Nakamura, Kanagawa (JP)

Correspondence Address: William S. Frommer, Esq., FROMMER LAWRENCE & HAUG LLP, 745 Fifth Avenue, New York, NY, 10151, US

(21) Appl. No.: 09/805,400

(22) Filed: Mar. 13, 2001

(30) Foreign Application Priority Data
Mar. 14, 2000 (JP) 2000-070898

(51) Int. Cl. G06F 17/00; G06F 15/16

(52) U.S. Cl. 707/104.1; 705/28; 709/219; 725/147; 725/149

(57) ABSTRACT

An information delivery system includes an information delivery apparatus installed at a sales company and receiver apparatuses installed at sales shops. A control unit generates program information data from stored program contents including catalog information, and generates delivery schedule information data based on stored delivery information. The program information data and the delivery schedule information data are transmitted by a broadband transmitter unit to the receiver apparatuses. The delivery schedule information is also transmitted to the receiver apparatuses, as required, via a narrowband communication path. In each receiver apparatus, a broadband receiver unit and a narrowband receiver unit receives the program information data and the delivery schedule information data, and the program contents are retrieved as desired and stored. A display unit displays the retrieved catalog information under the control of an information retrieval control unit.

### BACKGROUND OF THE INVENTION

1. Field of the Invention

The present invention relates to an information delivery system, an information delivery apparatus, a receiver apparatus, and an information delivery method, particularly for use in push-type information delivery.

2. Description of the Related Art

Conventionally, so-called push-type information delivery systems have been used. In the push-type information delivery systems, the sender of information regularly transmits information provided by subscribed information services such as news and articles is regularly delivered to a recipient. The recipient stores the transmitted information in a storage device, accesses the storage device to display the information on a monitor.

The mainstream of the currently available push-type information delivery services is to deliver information of small volumes, such as news and articles. The information is transmitted via a narrowband communication path such as the Internet including the public switched telephone network (PSTN) for storage in the storage device on the recipient side. The recipient, using a browser, accesses the storage device to display desired information on the monitor.

The information delivered in the conventional push-type information delivery systems has been small in volume; thus, the narrowband communication path has been sufficient for transmission thereof. The narrowband transmission path provides high reliability of transmission, i.e., causes few errors during transmission. The required storage capacity of the storage device has also been relatively small. Thus, the recipient is allowed to regularly receive information of subscribed information services.

The conventional push-type information delivery systems, however, are not suitable for transmitting information of large volumes. The small-volume information conventionally delivered in push-type information delivery systems allows transmission via the narrowband communication path, and in addition, does not require much consideration for the amount of free area in the storage device. On the other hand, large-volume information such as picture and sound of high quality requires transmission via a broadband communication path, and even if transmitted via the broadband communication path, requires long time for transmission. Furthermore, if files of large volumes are directly sent to the storage device, the storage device does not accommodate all the files. Thus, the recipient has been required to obtain the latest delivery schedule information in advance and to select desired information based on the delivery schedule information.

Furthermore, if the broadband communication path is implemented by a communications satellite, errors may be generated during transmission due to weather conditions. When information is transmitted simultaneously to a plurality of receiver apparatuses via communications satellite, even if information is not properly received by one of the receiver apparatuses, the information is hardly retransmitted. In particular, if delivery schedule information is not properly received, it is impossible to receive desired information based on the delivery schedule.

In addition, the conventional push-type information delivery systems are not easy to use for inexperienced users. Conventionally, each time a browser program for displaying the subscribed information is updated, the new browser program has had to be downloaded from a website and installed on the receiver apparatus. This is rather complex and troublesome for the inexperienced users.

Furthermore, when displaying the received information on a display apparatus not connected to the information retrieval and delivery apparatus, a browser program has had to be installed on the information retrieval and display apparatus, which is also complex and troublesome to the inexperienced users.

### SUMMARY OF THE INVENTION

Accordingly, it is an object of the present invention to provide an information delivery system, an information delivery apparatus, a receiver apparatus, and an information delivery method, which serve to deliver program contents of large volumes to the recipient and to save trouble for the recipient.

To this end, according to one aspect of the present invention, an information delivery system including an information delivery apparatus and a receiver apparatus, in which information is automatically pushed from the information delivery apparatus to the receiver apparatus, is provided. The information delivery apparatus includes a program content storage unit for storing the contents of a plurality of programs; a delivery information storage unit for storing delivery information corresponding to each of the plurality of programs; an information delivery control unit for selecting a program for current delivery from the plurality of programs, and for generating program information data and delivery schedule information data, the program information data including the contents of the selected program and the delivery schedule information data including the delivery information of the selected program; a broadband transmitter unit for transmitting the program information data and the delivery schedule information data via a broadband communication path; and a narrowband transmitter unit for transmitting the delivery schedule information data via a narrowband communication path. The receiver apparatus includes a broadband receiver unit for receiving the program information data and the delivery schedule information data transmitted via the broadband communication path; a narrowband receiver unit for receiving the delivery schedule information data transmitted via the narrowband communication path; an information retrieval control unit for retrieving as desired the program information data received by the broadband receiver unit with reference to the delivery schedule information data received by either the broadband receiver unit or the narrowband receiver unit; a received data storage unit for storing the retrieved program information data and the delivery schedule information data; and a display unit for displaying, under the control of the information retrieval control unit, information in accordance with the retrieved program information data stored in the received data storage means.

In accordance with the information delivery system as defined above, in the information delivery apparatus, the program content storage unit stores the contents of the plurality of programs, and the delivery information storage unit stores the delivery information corresponding to each of the plurality of programs. The information delivery control unit selects the program for current delivery from the plurality of programs based on the delivery information, and generates the program information data including the contents of the program, and the delivery schedule information data including the delivery information corresponding to the program. The broadband transmitter unit transmits the program information data and the delivery information data via the broadband communication path. The narrowband communication path transmits the delivery information data via the narrowband communication path. In the receiver apparatus, the broadband receiver unit receives the program information data and the delivery schedule information data transmitted via the broadband communication path. The narrowband receiver unit receives the delivery schedule information transmitted via the narrowband communication path. The information retrieval control unit retrieves desired information data from the program information data based on the delivery schedule information data. The received data storage unit stores the retrieved information data and the delivery schedule information data. The display unit displays the information in accordance with the retrieved information data under the control of the information retrieval and control unit.

According to another aspect of the present invention, an information delivery apparatus for an information delivery system and which automatically delivers information is provided. The information delivery apparatus includes a program content storage unit for storing the contents of a plurality of programs; a delivery information storage unit for storing delivery information corresponding to each of the plurality of programs; an information delivery control unit for selecting a program for current delivery from the plurality of programs, and for generating program information data and delivery schedule information data, the program information data including the contents of the selected program and the delivery schedule information data including the delivery information of the selected program; a broadband transmitter unit for transmitting the program information data and the delivery schedule information data via a broadband communication path; and a narrowband transmitter unit for transmitting the delivery schedule information data via a narrowband communication path.

In accordance with the information delivery apparatus as defined above, the program content storage unit stores the contents of the plurality of programs, and the delivery information storage unit stores the delivery information corresponding to each of the plurality of programs. The information delivery control unit selects the program for current delivery from the plurality of programs based on the delivery information, and generates the program information data including the contents of the program, and the delivery schedule information data including the delivery information corresponding to the program. The broadband transmitter unit transmits the program information data and the delivery information data via the broadband communication path. The narrowband communication path transmits the delivery information data via the narrowband communication path.

According to another aspect of the present invention, a receiver apparatus for an information delivery system and which receives information is provided. The receiver apparatus includes a broadband receiver unit for receiving program information data and delivery schedule information data transmitted via a broadband communication path from an information delivery apparatus; a narrowband receiver unit for receiving the delivery schedule information data transmitted via a narrowband communication path from the information delivery apparatus; an information retrieval control unit for retrieving as desired the program information data received by the broadband receiver unit with reference to the delivery schedule information data received by either the broadband receiver unit or the narrowband receiver unit; a received data storage unit for storing the retrieved program information data and the delivery schedule information data; and a display unit for displaying, under the control of the information retrieval control unit, information in accordance with the retrieved program information data stored in the received data storage unit.

In accordance with the receiver apparatus as defined above, the broadband receiver unit receives the program information data and the delivery schedule information data transmitted via the broadband communication path. The narrowband receiver unit receives the delivery schedule information transmitted via the narrowband communication path. The information retrieval control unit retrieves desired information data from the program information data based on the delivery schedule information data. The received data storage unit stores the retrieved information data and the delivery schedule information data. The display unit displays information in accordance with the retrieved information data under the control of the information retrieval and control unit.

According to another aspect of the present invention, an information delivery method, in which information is automatically pushed from an information delivery apparatus to a receiver apparatus, is provided. The information delivery method includes the steps of the information delivery apparatus: storing the contents of a plurality of programs and delivery information corresponding to each of the plurality of programs; transmitting program information data including the contents of one of the plurality of programs, and delivery schedule information data including the delivery information corresponding to the program via a broadband communication path; and transmitting, as required, the delivery schedule information data via a narrowband communication path. The information delivery method also includes the steps of the receiver apparatus: receiving the program information data and the delivery schedule information data transmitted via the broadband communication path; receiving the delivery schedule information data transmitted, as required, via the narrowband communication path; storing the program information data and the delivery schedule information data; and displaying information in accordance with the program information data and the delivery schedule information data.

In accordance with the information delivery method, the information delivery apparatus stores the contents of the plurality of programs and the delivery information corresponding to each of the plurality of programs, and based on the delivery information, transmits the program information data and the delivery schedule information data via the broadband communication path. The information delivery apparatus also transmits, as required, the program information data and the delivery information data via the narrowband communication path. The receiver apparatus receives and stores the program information data and the delivery information data transmitted via the broadband communication path and the narrowband communication path, and displays information in accordance therewith.

According to another aspect of the present invention, an information delivery method, in which information is automatically pushed from an information delivery apparatus to a receiver apparatus, is provided. The information delivery method includes the steps of the information delivery apparatus: storing, together with the contents of a plurality of programs, at least one browser program for reading the contents of the at least one program; and transmitting predetermined information data including the contents of one of the at least one program and one of the at least one browser program corresponding to the program via a broadband communication path. The information delivery method also includes the steps of the receiver apparatus: receiving the predetermined information data including the contents and the browser program, transmitted via the broadband communication path; storing, in accordance with a predetermined directory structure, the contents, and the browser program if the browser program has been updated; and displaying the contents using the browser.

In accordance with the information delivery method, the information delivery apparatus stores, together with the contents of the plurality of programs, at least one browser program for reading the contents of the plurality of programs, and transmits program information data including the contents of one of the programs and one of the at least one browser program corresponding to the program via the broadband communication path. The receiver apparatus receives the program information data including the contents and the browser program, and stores the contents in a first predetermined area of a storage unit, and if the browser program has been updated, stores the browser program in a second predetermined area of the storage unit. The receiver apparatus displays information in accordance with the program information data and the delivery schedule information data as required, using the new browser program.

According to another aspect of the present invention, an information delivery method for delivering product catalog information from an information delivery apparatus to a receiver apparatus is provided. The information delivery method includes the steps of electronically creating at least one product catalog information file of the product catalog information, including motion picture data and sound data; generating a delivery schedule for delivering the at least one product catalog information file; and transmitting the at least one product catalog information file and the delivery schedule so that the receiver apparatus is allowed to receive the at least one product catalog information file in accordance with the delivery schedule.

According to another aspect of the present invention, an information delivery method for delivering product catalog information from an information delivery apparatus to a receiver apparatus is provided. The information delivery method includes the steps of electronically creating at least one product catalog information file of the product catalog information, including motion picture data and sound data; generating a delivery schedule for delivering the at least one product catalog information file; and transmitting the at least one product catalog information file and the delivery schedule so that the receiver apparatus is allowed to play back the motion picture data and sound data included in the at least one product catalog information file in accordance with the delivery schedule.

According to another aspect of the present invention, an information delivery method for delivering product catalog information from an information delivery apparatus to a receiver apparatus is provided. The information delivery method includes the steps of electronically creating at least one product catalog information file of the product catalog information; generating a delivery schedule for delivering the at least one product catalog information file; and transmitting the at least one product catalog information file while transmitting the delivery schedule via a narrowband communication path and the delivery schedule via a broadband communication path so that the receiver apparatus receives the at least one product catalog information file in accordance with the delivery schedule.

In accordance with the present invention, in which delivery information is transmitted together with the program contents, the receiver apparatus is allowed to retrieve the program contents as desired with reference to the delivery information. Thus, the received data storage unit in the receiver apparatus is prevented from exhausting its storage capacity. In addition, the delivery schedule information data can be transmitted via the narrowband communication path, which provides high reliability of transmission, as well as via the broadband communication path, ensuring delivery of the delivery schedule information data. Accordingly, program contents of large volumes are allowed to be transmitted via the broadband communication path. Furthermore, it is ensured that the receiver apparatus is allowed to retrieve only desired information.

The present invention also allows the latest catalog information to be transmitted to information terminals installed at sales shops and thereby provided to the customer. The catalog information may include motion picture, sound, interactive data, etc., providing richer and more adequate product information compared with printed catalogs.

### BRIEF DESCRIPTION OF THE DRAWINGS

FIG. 1 is a block diagram of an information delivery system according to an embodiment of the present invention;

FIG. 2 is a flowchart of a processing for delivering information via a broadband communication path in an information delivery apparatus constituting the information delivery system;

FIG. 3 is a diagram showing an example of configuration of information data in the information delivery system;

FIG. 4 is a flowchart of a processing for delivering information via a narrowband communication path in the information delivery apparatus;

FIG. 5 is a flowchart of a processing for receiving information in a receiver apparatus constituting the information delivery system;

FIG. 6 is a flowchart of a processing for reserving programs in the receiver apparatus;

FIG. 7 is a diagram showing an example of time overlap among programs;

FIGS. 8A and 8B are diagrams showing examples of changing reservation setting in the receiver apparatus;

FIGS. 9A and 9B are diagrams showing examples of reservation setting in the receiver apparatus;

FIGS. 10A and 10B are diagrams showing examples of screen in the receiver apparatus;

FIG. 11 is a block diagram of a receiver apparatus, as connected to a peripheral apparatus, according to a modification of the embodiment; and

FIGS. 12A and 12B are diagrams showing examples of data structures in the receiver apparatus and in an information storage medium, respectively.

### DESCRIPTION OF THE PREFERRED EMBODIMENTS

Preferred embodiments of the present invention will now be described with reference to the accompanying drawings.

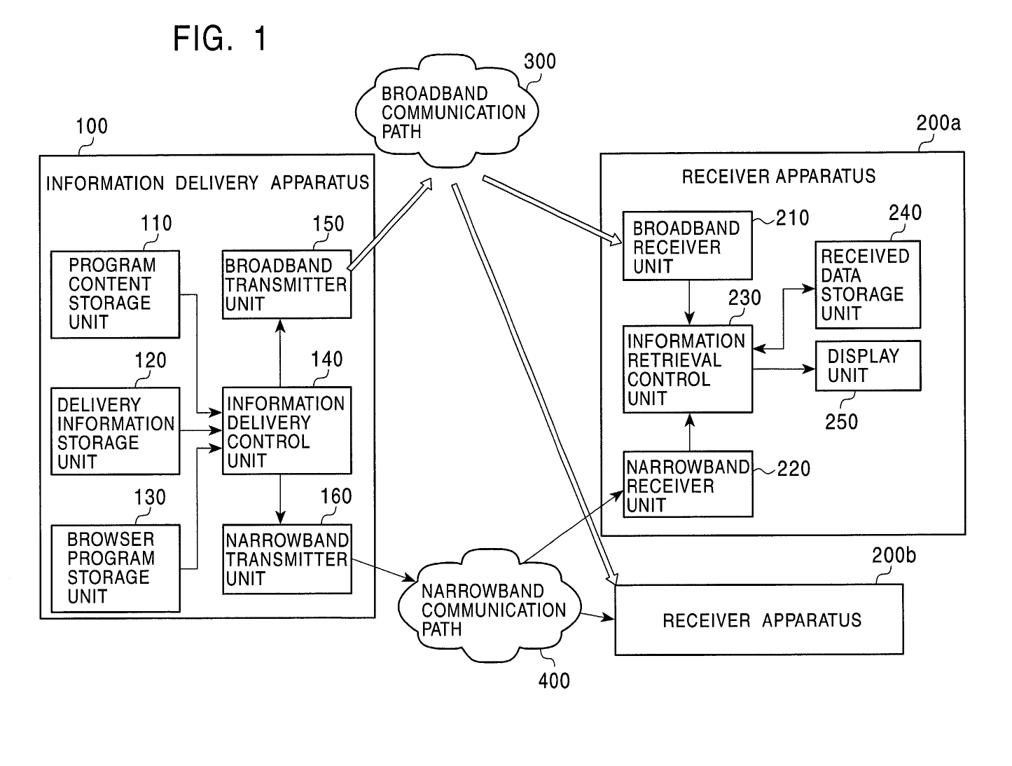

FIG. 1 is a block diagram of an information delivery system according to an embodiment of the present invention. Referring to FIG. 1, the information delivery system according to the embodiment includes an information delivery apparatus 100 which delivers information, and receiver apparatuses 200a and 200b which receive information delivered by the information delivery apparatus 100. The receiver apparatuses 200a and 200b are linked to the information delivery apparatus 100 via a broadband communication path 300 implemented, for example, by a communications satellite, and also via a narrowband communication path 400, for example, the Internet including the public switched telephone network (PSTN).

In this embodiment, the information delivery apparatus 100 is assumed to be a web server installed at a sales company which sells information equipment products such as computers, video cameras, television receivers, video cassette recorders, and DVD players. The receiver apparatuses 200a and 200b are assumed to be information terminals provided by the sales company and installed at sales shops where the information equipment products are actually sold to the customer. That is, the sales company provides the information equipment products and let the sales shops sell the information equipment products to the customer. It is to be appreciated, however, that the information delivery apparatus 100 is not limited to the web server installed at the sales company and may be of any type, with the receiver apparatuses 200a and 200b being of any type compatible with the information delivery apparatus 100.

The information delivery apparatus 100 installed at the sales company includes a program content storage unit 110 for storing contents of programs to be delivered, a delivery information storage unit 120 for storing delivery information corresponding to each of the programs, a browser program storage unit 130 for storing browser programs corresponding to the programs, an information delivery control unit 140 for controlling delivery of the programs, the delivery information, and the browser programs stored in the respective storage units, a broadband transmitter unit 150 for transmitting of information via the broadband communication path 300, and a narrowband transmitter unit 160 for transmitting information via the narrowband communication path 400.

The program content storage unit 110 is a database of contents of programs to be delivered. The contents may include, for example, still picture, motion picture, sound, graphics, text, and interactive data. The delivery information storage unit 120 is a database of delivery information corresponding to each of the programs. More specifically, the delivery information is a set of information relating to each of the programs, including program name, time of delivery, channel number if a plurality of channels are available in the broadband communication path 300, properties relating to delivery, including delivery status and priority, type and size of program contents, and storage area in the receiver apparatuses 200a and 200b. The browser program storage unit 130 is a database of browser programs which are delivered as desired to the receiver apparatuses 200a and 200b for retrieval and display of desired information. The information delivery control unit 140 selects a program for current delivery based on the delivery information stored in the delivery information storage unit 120. The information delivery control unit 140 then generates program information data including the contents of the program and the browser program corresponding to the program, and delivery schedule information data including the delivery information of the program. The broadband transmitter unit 150, under the control of the information delivery control unit 140, delivers the program information data and the delivery schedule information data via the broadband communication path 300. In this embodiment, the broadband communication path 300 is implemented by a communications satellite, and includes a plurality of channels. The narrowband transmitter unit 160, under the control of the information delivery control unit 140, delivers as required the delivery schedule information data via the narrowband communication path 400.

In this embodiment, a “program” provides catalog information for information equipment, and “program contents” refers to catalog information for products provided by the sales company. Usually, catalogs are provided for each of the products sold at the sales shops in order to provide product information to the customer. The catalogs are created for each of the products by the sales company, and is provided to the sales shops for sales promotion of the products. The cycles of providing new products and updated versions has become as short as several weeks for products such as computers. However, catalogs for such products are not created so quick, failing to provide adequate product information to the customer.

The information delivery system according to this embodiment overcomes this problem. More specifically, in the information delivery system according to this embodiment the sales company creates programs including electronic catalog information describing the product information, and delivers the programs to information terminals provided at the sales shops, so that the customer is allowed to view the latest catalog information displayed on the information terminals. The catalog information may include motion picture, sound, interactive data, etc. in addition to text data, related to the products, so that, compared with printed catalogs, richer and more adequate product information is provided to the customer.

Turning to the receiver apparatuses 200a and 200b, assuming that the broadband communication channel 300 is a broadcasting satellite, information can be received simultaneously by a plurality of receiver apparatuses, 200a and 200b in FIG. 1. The receiver apparatuses 200a and 200b are constructed identically, and thus description is made herein only to the receiver apparatus 200a.

The receiver apparatus 200a includes a broadband receiver unit 210 for receiving the information data transmitted via the broadband communication path 300, a narrowband receiver unit 220 for receiving the information data delivered via the narrowband communication path 400, an information retrieval control unit 230 for retrieving desired information data from the received information data, a retrieved data storage unit 240 for storing the retrieved information data, and a display unit 250 for displaying information based on the retrieved information data.

The broadband receiver unit 210 receives the program information data including the program contents and the browser program, and delivery schedule information data including the delivery information, delivered via the broadband communication path 300, and forwards to the information retrieval control unit 230. The narrowband receiver unit 220 receives the delivery schedule information data delivered via the narrowband communication path 400, including the delivery information, and forwards to the information retrieval control unit 230. The information retrieval control unit 230 stores the received delivery information in the received data storage unit 240, and determines whether or not to retrieve the program with reference to the delivery information. Thus, desired data is retrieved from the received information data, and the retrieved data is stored in the received data storage unit 240. The received browser program is stored in a predetermined area of the received data storage unit 240. The received data storage unit 240 stores in predetermined areas the delivery information, program contents which are allowed to be received, and the browser program. The browser displays on the display unit 250 information in accordance with the information data stored in the received data storage unit 240.

The broadband communication path 300 is a communications satellite in this embodiment, which is capable of delivering a great amount of data at a time and is thus suitable for delivering information files of large volumes. The communications satellite allows information files of large volumes to be simultaneously delivered to a plurality of receiver apparatuses. The communications satellite, however, suffers from problems, for example, that the reliability of data transmission is affected by weather conditions.

The narrowband communication path 400 is the Internet including PSTN in this embodiment, which is not capable of delivering information files of large volumes, but which provides a high reliability and which is not affected by weather conditions.

Description now proceeds to the operation of the information delivery system configured as described above and an information delivery method implemented by the information delivery system. In the information delivery apparatus 100, the contents of a plurality of programs are stored in the program content storage unit 110, the delivery information corresponding to each of the programs is stored in the delivery information storage unit 120, and browser programs are stored in the browser program storage unit 130. The information delivery control unit 140 selects a program for current delivery based on the delivery information stored in the delivery information storage unit 120, and generates information data for the program. The broadband transmitter unit 150 delivers the program contents, the delivery information, and the browser program via the broadband communication path 300. The narrowband transmitter unit 160 transmits the delivery information via the narrowband communication path 400.

In the receiver apparatus 200a, the broadband receiver unit 210 receives the program contents, the delivery information, and the browser program transmitted via the broadband communication path 300. The narrowband receiver unit 220 receives the delivery information delivered via the narrowband communication path 400. The information retrieval control unit 230 stores the received delivery information in the received data storage unit 240, determines whether the program contents be received with reference to the delivery schedule, and stores in the received data storage unit 240 program contents which is allowed to be received. The received browser program is stored in a predetermined area of the received data storage unit 240. The display unit 250 displays information in accordance with the program contents in the received data storage unit 240 under the control of the information retrieval control unit 230.

Because the information delivery apparatus 100 delivers the delivery information together with the program contents, the receiver apparatus 200a is allowed to reserve in advance desired programs based on the delivery information and thereby not to receive undesired programs. Furthermore, because the delivery information is also transmitted via the narrowband communication path 400, the delivery information can be obtained even if it is not obtained via the broadband communication path 300, for example, due to weather conditions. The program contents are delivered via the broadband communication path 300, allowing delivery of multimedia information of large volume. In addition, the program contents can be received or not received as desired, decreasing the required capacity of the received data storage unit 240.

Next, processing for information delivery in the information delivery apparatus is described in further detail.

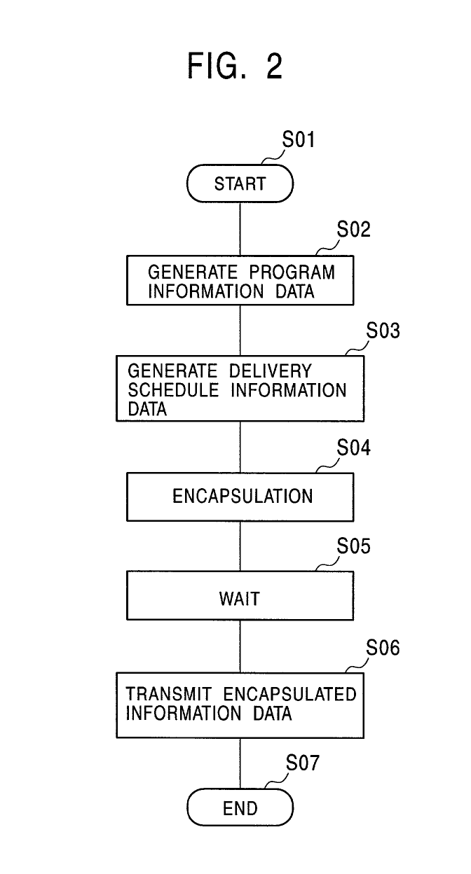

FIG. 2 is a flowchart of a processing for information delivery in the information delivery apparatus 100 using the broadband communication path 300. In this embodiment, the broadband communication path 300 is implemented by a communications satellite.

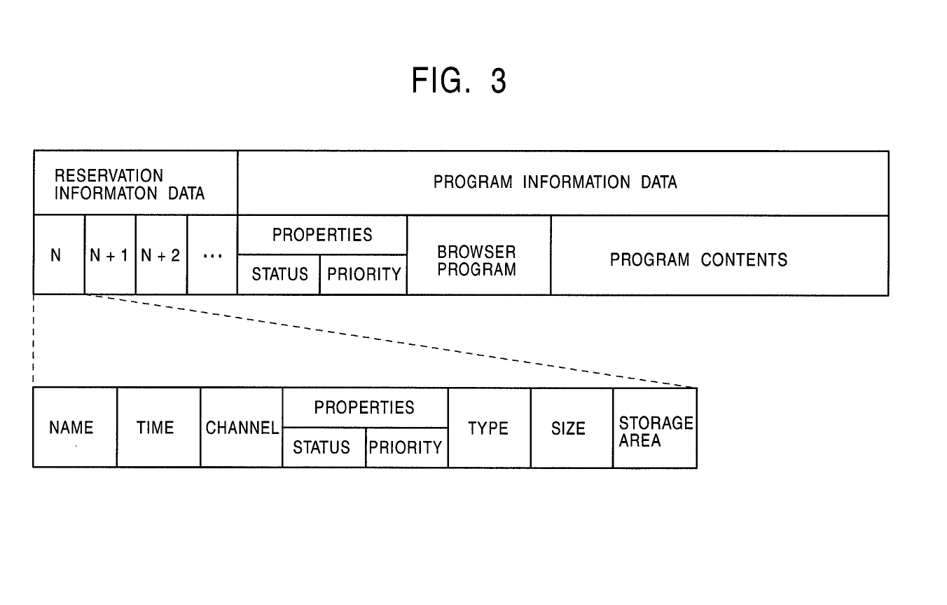

When the processing for information delivery starts in step S01, a program is selected for current delivery, and program information data for the program is generated in step S02. At this time, a browser program corresponding to the program is included in the program information data as desired. Next, delivery schedule information data, including delivery information for the current and subsequent delivery operations, is generated in step S03. The delivery schedule information data is called reservation information when used in the receiver apparatus for program reservation setting. The program information data and the delivery schedule information data are generated in accordance with a predetermined communications protocol, for example, as shown in FIG. 3.

FIG. 3 shows an example of the configuration of the information data in the information delivery system. Referring to FIG. 3, the information data is constituted of reservation information data and program information data. The reservation information data includes the delivery information of the program to be delivered in the current (Nth) operation, and the delivery information of programs to be delivered in subsequent (N+1 th) (N+2 th) delivery operations. The delivery information corresponding to each of the programs includes name, time, channel number, properties including status and priority, type, size, and storage area. The name field indicates the name of the program. The time field indicates the time of delivery of the program. The channel number field indicates which of the channels in the broadband communication path 300 is used. The status field indicates whether the program is to be transmitted for the first time. The priority field indicates priority levels for reception among programs simultaneously transmitted via a plurality of channels in the broadband communication path 300. The type field indicates the type of program contents, i.e., image, sound, graphics, text, etc. The size field indicates the size of the program contents. The storage area field indicates in which directory the program contents will be stored in the received data storage unit 240.

The program information data includes the program contents, the browser program, and the properties in the delivery information of the program which is being transmitted. The program contents may include image, sound, graphics, text, etc.

Referring back to FIG. 2, the generated information data is encapsulated in accordance with a predetermined communications protocol in step S04, forwarded to a storage unit (not shown) in the broadband transmitter unit 150, and waits until a predetermined time of transmission in step S05. The information is transmitted via the broadband communication path 300 in step S06, and the processing completes in step S07.

The reservation information data is also transmitted, as required, via the narrowband communication path 400. In many software programs for push-type information delivery, the receiver apparatus fetches information from the information delivery apparatus in accordance with a schedule determined by the client software. The information delivery apparatus in this embodiment transmits the reservation information on receiving a request from the client software.

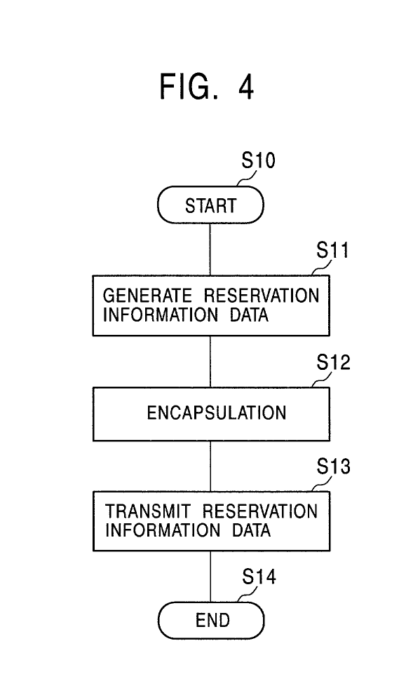

FIG. 4 is a flowchart of a processing for delivering information via the narrowband communication path 400 in the information delivery apparatus 100. The processing starts when a request from the receiver apparatus 200a is received by the narrowband transmitter unit 160 in step S10. In step S11, the reservation information data is generated based on the delivery information of the program currently being delivered and the delivery information of programs for subsequent delivery operations. The reservation is encapsulated in accordance with a predetermined communications protocol in step S12, and transmitted by the narrowband transmitter unit 160 in step S13, and the processing completes in step S14.

As described above, the information delivery apparatus 100 transmits the program contents, the delivery information, and the browser program via the broadband communication path 300, allowing delivery of information of large volumes. In addition, when the delivery information is not properly received by the receiver apparatus 200a, for example, due to weather conditions, the delivery information is transmitted via the narrowband communication path 400, ensuring delivery of information.

Next, description is made to processing for receiving information by the receiver apparatus according to the embodiment.

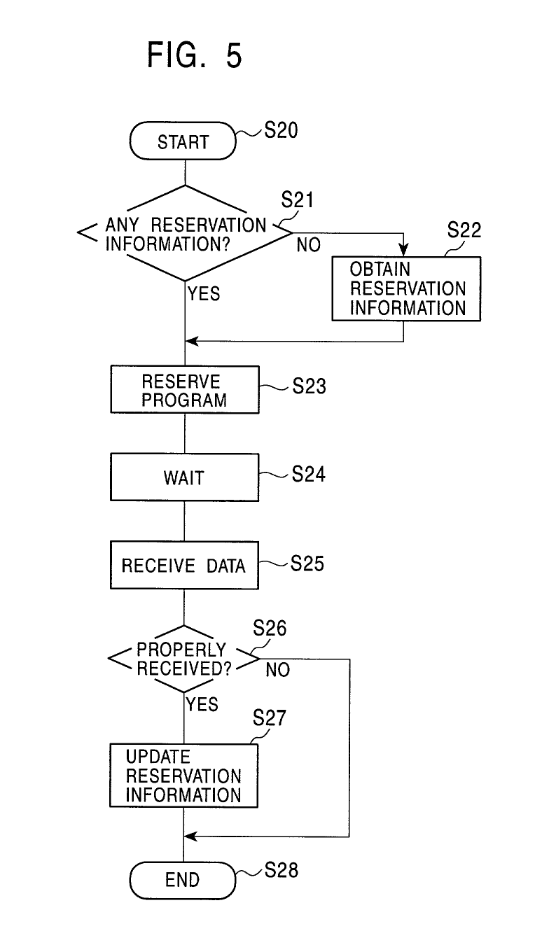

FIG. 5 is a flowchart of processing for receiving information by the receiver apparatus according to the embodiment. When the processing starts in step S20, the information retrieval control unit 230 determines whether any reservation information data is stored in the received data storage unit 240 in step S21. If the reservation information data has been properly obtained via the broadband communication path 300, it is determined that the reservation information data exists, and the processing proceeds to step S23. If the reservation information data has not been obtained via the broadband communication path 300, for example, due to weather conditions, it is determined that the reservation information data does not exist. Then, the receiver apparatus sends a request for reservation information data to the information delivery apparatus 100 via the narrowband communication path 400, and thereby obtains the reservation information data in step S22. When the reservation information data exists, or is obtained, the contents of the reservation information data is displayed on the display unit 250. The user reserves desired programs based on the reservation information data in step S23. The details of reservation setting will be described later herein. When reservation is made, the receiver apparatus waits in step S24 until any reserved program is transmitted. When a program is transmitted via the information delivery apparatus 100 via the broadband communication path 300, the program is received in step S25 if the program has been reserved, and is then stored in the received data storage unit 240. in step S26, it is checked whether the program has been properly received. If the program has been properly received, the reservation information is updated in step S27, and the processing completes in step S28. When the program has not been properly received, the processing completes in step S28. Thus, the receiver apparatuses 200a and 200b reserves programs based on the obtained latest reservation information data, receives the reserved program in accordance with the delivery schedule. The reservation by the user may be made either based on the reservation information data or in advance based on user preference.

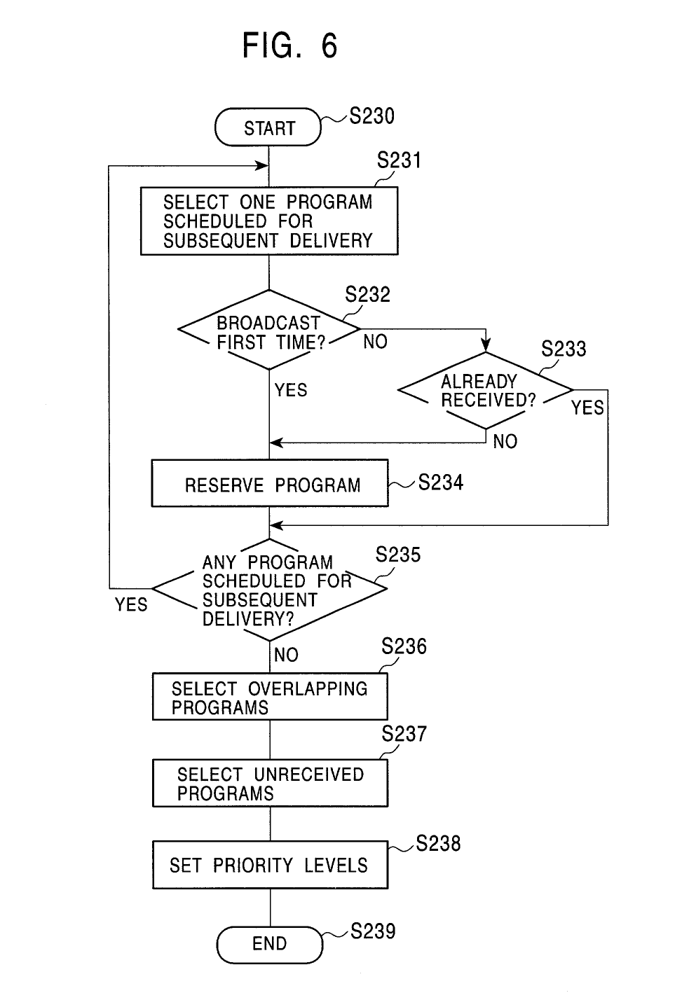

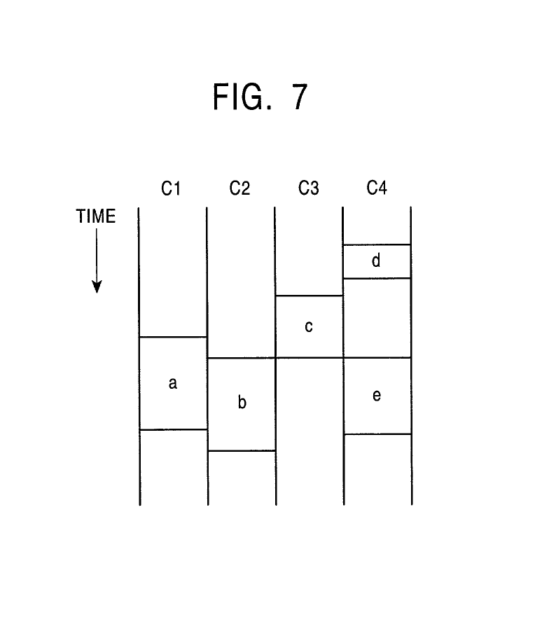

Next, description is made to program reservation setting. FIG. 6 is a flowchart of a processing for program reservation setting in the receiver apparatus according to the embodiment. Referring to FIG. 6, when the processing for program reservation setting starts in step S230, one of the programs which is next to be delivered is selected based on the obtained reservation information data in step S231. Then, in step S232, it is determined whether the program is to be transmitted for the first time. If it is found that the program is to be transmitted for the first time, the program is reserved in step S234. If it is found that the transmission of the program is not the first time, it is further determined in step S233 whether the program has already been received. If it is found that the program has not been received, the program is reserved in step S234. If it is found that the program has already been retrieved, the processing proceeds to step S235 without reserving the program. Then, it is determined in step S235 whether there is any program scheduled for delivery subsequent to the reserved program. If there is any, the processing returns to step S231 to reserve another program. If there is none, program reservation which has already been made is checked. First, in step S236, reserved programs which overlap in time are selected, if any. FIG. 7 shows an example of time overlap among a plurality of programs. Referring to FIG. 7, the programs, indicated by a to e, respectively, are delivered via a plurality of broadband communication channels C1, C2, C3, and C4. c and d are broadcast at different times, and thus, both can be properly received. With regard to a, b, and e, however, the broadcast times overlap with one another, prohibiting reception of all the programs. In such a case, one of the programs is selected for reservation in accordance with priority levels.

Referring back to FIG. 6, of the programs which overlap in broadcast time, programs which have not been received are selected in step S237. Then, priority levels are set to the selected programs in step S238, and the processing completes in step S238. Priority setting is made by selecting a desired program from the programs selected in step S237 and assigning priority levels in reservation setting information. Alternatively, priority setting may be such that a plurality of programs is selected and different priority levels are given thereto. The priority levels allow the programs to be received in accordance therewith even when the delivery schedule is changed.

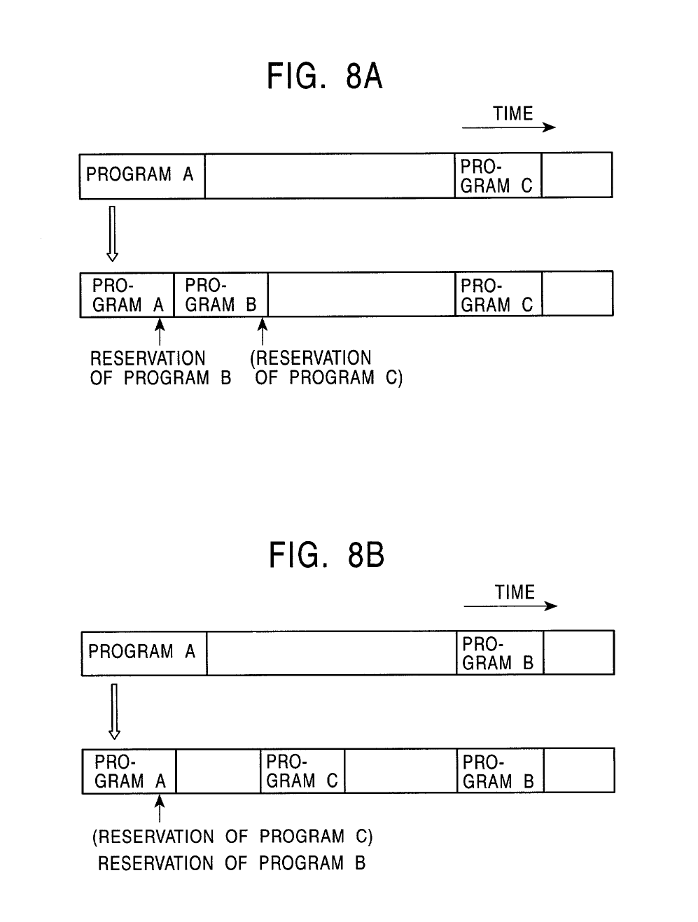

The delivery schedule continuously changes as time proceeds, and the program reservation setting also changes in accordance therewith. FIGS. 8A and 8B show, by way of example, cases where changes are made to program reservation setting in the receiver apparatus.

FIG. 8A shows an example of change in program reservation setting, in which a different program is delivered while a program is being received. Originally, program A and program C were supposed to be received. When delivery information of the program A is obtained, the program A is reserved, and the contents of the program A is obtained as the program A is transmitted. Let is be assumed that while the contents of the program A is being received, the delivery schedule is changed, and delivery of a program B starts. In this case, while the program A is being received, the delivery information for the program B is obtained in the reservation information data. When the delivery information of the program B is obtained, if the program B is desired to be received, the program B is reserved. In accordance with the reservation setting, delivery of the program B starts. As for program C, the delivery information is obtained while the program A or the program B is being received, and the program C is then reserved, if so desired, so that the program C is received as originally planned. It is to be understood that alternatively the reservation setting for the program C may be made in advance.

FIG. 8B shows an example of change in program reservation setting, in which a new program is added in the course of broadcast. Originally, a program A and a program B were supposed to be received. Let it be assumed that the delivery schedule is changed and a program C is added. In this case, the program C is reserved when the delivery information of the program C is obtained, and the program C is received before the program B is received.

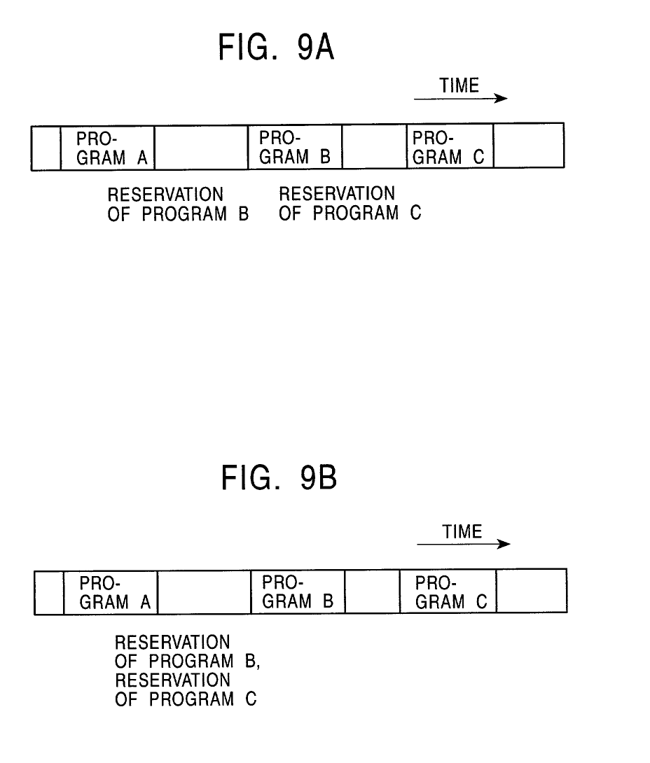

Although not made apparent in the above description, reservation setting may be made on a program by program basis, or simultaneously for a plurality of programs. FIGS. 9A and 9B are diagrams showing examples of reservation setting in the receiver apparatus.

FIG. 9A shows an example in which reservation of a subsequent program is made while a reserved program is being received. Referring to FIG. 9A, while a program A is being received, a subsequent program B is reserved. Similarly, reservation for the program C is made while the program B is being received. This is particularly effective, for example, when it is desired that the programs be properly obtained in accordance with the priority levels, for example, due to limited capacity of the received data storage unit.

FIG. 9B shows an example in which a plurality of programs is simultaneously reserved. Referring to FIG. 9B, reservation for programs B and C is made while a program A is being received. This approach ensures reception of the program C even if the program B fails to be received. Either approach is employed as desired in implementing the present invention.

Next, reception of a browser program is described. As described earlier, the information delivery apparatus 100 delivers a browser program together with the contents of a program via the broadband communication path 300. The receiver apparatuses 200a and 200b each store the received browser program in a predetermined directory of the respective received data storage units. Then, it is checked whether the browser program has been updated. If the browser program is found to be updated, the browser is written in a predetermined directory so as to be automatically installed. As described above, together with the contents of a program, a browser program corresponding to the program is delivered. Even if the delivered program is incompatible with a browser already installed on the receiver apparatus, a browser program which is compatible with the program is delivered together with the contents of the program. The receiver apparatus overwrites the older browser program stored in the predetermined directory in the received data storage unit with the new browser program, automatically installing the new browser program. Accordingly, the information retrieval control unit 230 is allowed to acknowledge the new browser, retrieve the received program contents, and display information in accordance therewith.

Thus, the receiver apparatus receives the contents of a program and a corresponding browser program, eliminating the need to check browser compatibility and the need to download browsers.

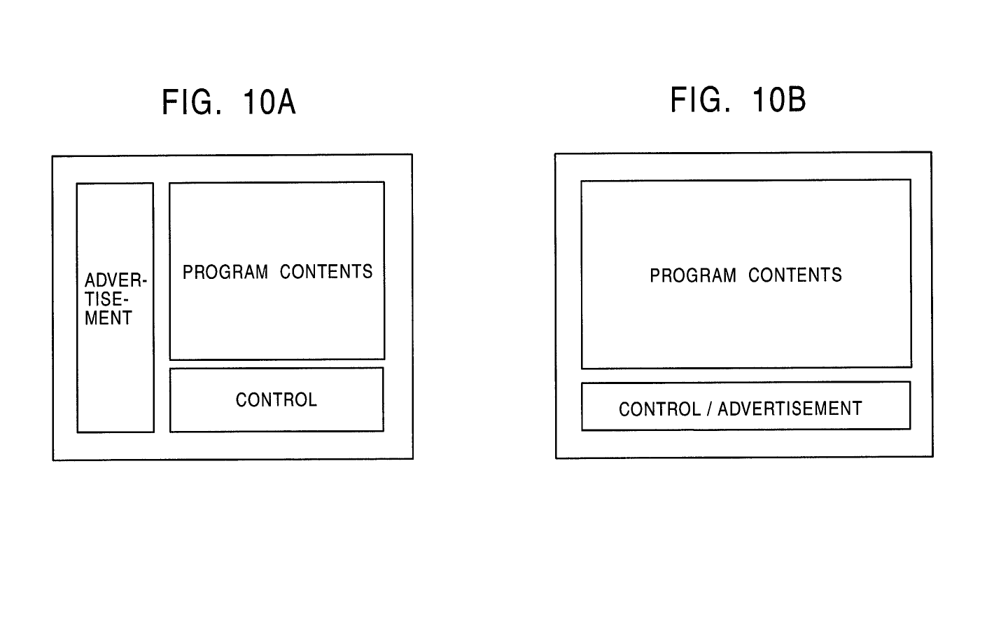

The browser program also designates a display format for the program contents and the delivery schedule information data. FIGS. 10A and 10B show examples of a screen displayed on the display unit by the browser in the receiver apparatus. As shown in FIGS. 10A and 10B, the browser program changes the display format of program contents, advertisements, etc. to update the portal screen. The program contents are often changed particularly when transmitting large-volume information such as image and sound. The receiver apparatus saves the trouble of downloading a new browser program from a different website, even when the processing algorithm for the program contents and the delivery schedule information data changes, which is quite advantageous for information delivery in which the algorithm often changes.

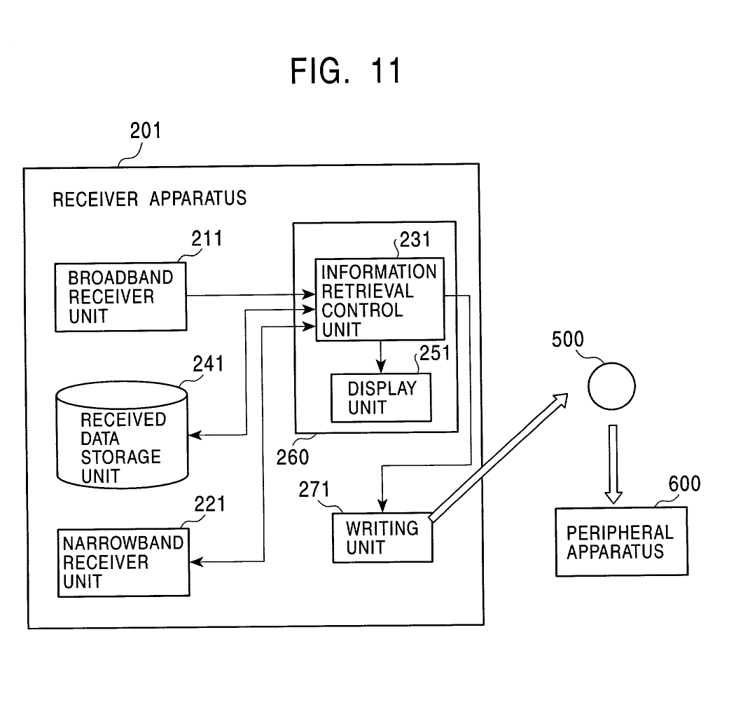

In a modification of the above-described embodiment, the arrangement may be such that program contents obtained by a receiver apparatus is transferred to a peripheral apparatus, as shown in the block diagram of FIG. 11.

Referring to FIG. 11, a receiver apparatus 201 includes a broadband receiver unit 211, a narrowband transmitter unit 221, an information retrieval and display unit 260 including an information retrieval control unit 231 and a display unit 251, a received data storage unit 241, and a writing unit 271. The receiver apparatus 201 sends data to a peripheral unit 600 via an information storage medium 500.

The broadband receiver unit 211 receives the contents of a program, a browser program corresponding to the program, and delivery schedule information data, transmitted via a broadband communication channel, for example, a communications satellite, and forwards to the information retrieval unit 231. The information retrieval control unit 231 determines whether or not to retrieve the program contents. The narrowband receiver unit 221 sends a request, as required, to an information delivery apparatus via a narrowband communication path, typically the Internet, and thereby obtains the delivery schedule information data. The delivery schedule information data is forwarded to the information retrieval unit 231. The information retrieval and display unit 260 is, for example, a personal computer, and includes the information retrieval control unit 231 and the display unit 251. The information retrieval control unit 231 controls the broadband receiver unit 211 and the narrowband receiver unit 221, display of the retrieved program contents and the delivery schedule information data on the display unit 251 using the browser program, writing to the received data storage unit 241, and writing to the information storage medium 500 by the writing unit 271. The display unit 251 displays the program contents and the delivery schedule information data using the browser program under the control of the information retrieval control unit 231. The received data storage unit 241 stores the program contents, the browser program, and the delivery schedule information data under the control of the information retrieval control unit 231. The writing unit 271 writes information stored in the received data storage unit 241 to the information storage medium 500 under the control of the information retrieval unit 231. The information storage medium 500 is used to store information to be transferred from the receiver apparatus 201 to the peripheral apparatus 600. The peripheral apparatus 600 has functionality equivalent to that of the information retrieval and display unit 260 of the receiver apparatus 201. The peripheral apparatus 600 reads the information stored in the information storage medium 500 and displays information in accordance therewith.

Next, the operation of the receiver apparatus 201, in which information is transferred from the receiver apparatus 201 to the peripheral apparatus 600, is described. The receiver apparatus 201 receives the program contents, the browser program, and the delivery schedule information data by the broadband receiver unit 211 and the narrowband receiver unit 221. The delivery schedule information data is provided in the form of reservation information data including delivery information for several programs. The browser program allows the receiver apparatus 201 and the peripheral apparatus 600 to display information. The program contents retrieved by the information retrieval control unit 231, the corresponding browser program, and the delivery schedule information data are stored in the received data storage unit 241. As required, the program contents and the delivery schedule information data are displayed on the display unit 251. Furthermore, information stored in the received data storage unit 241 is written to the information storage medium 500 by the writing unit 271, and is then supplied to the peripheral apparatus 600.

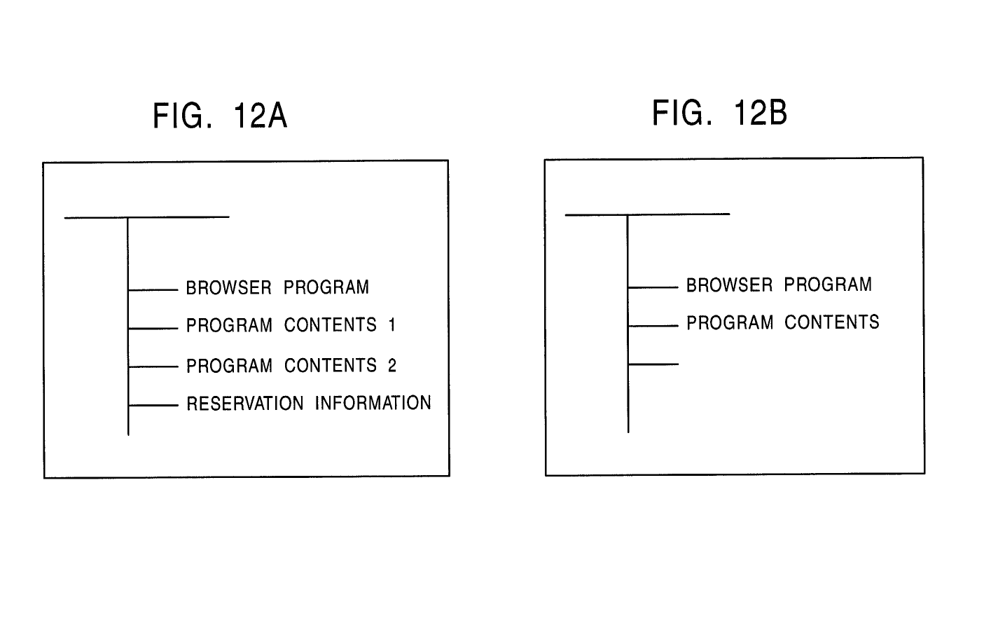

Transfer of the program contents and the browser program will be described in further detail. FIGS. 12A and 12B show examples of data structures in the receiver apparatus 201 and the information storage medium 500, respectively. Referring to FIG. 12A, the program contents, the browser program, and the reservation information data (delivery schedule information data) are stored in the received data storage unit 241 in accordance with a predetermined data structure. The received data storage unit 241 stores the browser program, program contents 1, program contents 2, and the reservation information data. The information retrieval control unit 231 writes the stored information to the information storage medium 500 via the writing unit 271, with the directory structure maintained. Referring to FIG. 12B, the browser program and the program contents are stored in the information storage medium 500 by the same directory structure. The browser program and the program contents stored in the information storage medium 500 are directly supplied to the peripheral apparatus 600.

Thus, the receiver apparatus 201 allows the program contents and the delivery schedule information data to be displayed on the peripheral apparatus 600 which is not connected to the information delivery apparatus 100, by sending, together with the program contents, the browser program corresponding to the program contents. This saves the trouble of downloading a new browser program from a website and installing the program on the peripheral apparatus 600.

The processing as described above can be implemented by a computer. The processing is written as a program and the program is stored in a computer-readable storage medium. The computer executes the program to implement the processing. The type of computer-readable storage medium includes magnetic storage medium and semiconductor memory. In order to distribute the program, the program may be stored in a portable storage media such as CD-ROMs and floppy disks, or be stored in a storage unit of a computer on a network so that the program can be downloaded by other computers. In executing the program, the program is stored typically in a hard disk incorporated in the computer, and loaded therefrom to a main memory.

What is claimed is:

1. An information delivery system comprising an information delivery apparatus and a receiver apparatus, in which information is automatically pushed from said information delivery apparatus to said receiver apparatus, said information delivery apparatus comprising:
program content storage means for storing the contents of a plurality of programs;
delivery information storage means for storing delivery information corresponding to each of said plurality of programs;
information delivery control means for selecting a program for current delivery from said plurality of programs, and for generating program information data and delivery schedule information data, said program information data including the contents of the selected program and said delivery schedule information data including the delivery information of the selected program;
broadband transmitter means for transmitting said program information data and said delivery schedule information data via a broadband communication path; and
narrowband transmitter means for transmitting said delivery schedule information data via a narrowband communication path;
said receiver apparatus comprising:
broadband receiver means for receiving said program information data and said delivery schedule information data transmitted via said broadband communication path;
narrowband receiver means for receiving said delivery schedule information data transmitted via said narrowband communication path;
information retrieval control means for retrieving as desired said program information data received by said broadband receiver means with reference to said delivery schedule information data received by either said broadband receiver means or said narrowband receiver means;
received data storage means for storing the retrieved program information data and said delivery schedule information data; and
display means for displaying, under the control of said information retrieval control means, information in accordance with the retrieved program information data stored in said received data storage means.

2. An information delivery system according to claim 1, wherein said delivery information of the selected program includes program name, time of delivery, channel designation information if a plurality of channels are available in said broadband communication path, delivery status as to whether the selected program is to be transmitted for the first time, priority level, and type and size of the contents of the selected program.

3. An information delivery system according to claim 1, wherein said delivery schedule information data includes, in addition to the delivery information of the selected program, the delivery information of at least one of said plurality of programs scheduled for subsequent delivery, whereby the delivery schedule information data serves as reservation information data which is used for program reservation setting in said receiver apparatus.

4. An information delivery system according to claim 1, wherein said narrowband transmitter means receives a request for said delivery schedule information data from said receiver apparatus and forwards said request to said information delivery control means, and in response to said request, said information delivery control means generates said delivery schedule information data, and said narrowband transmitter means transmits said delivery schedule information data to said receiver apparatus.

5. An information delivery system according to claim 1, wherein said information delivery apparatus further comprises browser program storage means for storing at least one browser program for reading the contents of said plurality of programs, said information delivery control means generating said program information data including one of said at least one browser program corresponding to the selected program in addition to the contents of the selected program.

6. An information delivery system according to claim 5, wherein said at least one browser program includes sufficient software which allows contents of any of said plurality of programs and said delivery schedule information data, transmitted from said information delivery apparatus, to be displayed on said display means of said receiver apparatus.

7. An information delivery system according to claim 1, wherein said display means displays said delivery schedule information data, said information delivery control means reserves at least one program, as selected based on said delivery schedule information data displayed on said display means, which is scheduled for subsequent delivery by said information delivery apparatus, thereby having said broadband receiver means receive only said at least one program which has been reserved, and said broadband receiver means receives only said at least one program which has been reserved.

8. An information delivery system according to claim 1, wherein when said delivery schedule information data fails to be properly obtained via said broadband communication path, said information retrieval means generates a request for said delivery schedule information data and forwards said request to said narrowband receiver means, said narrowband receiver means transmits said request to said information delivery apparatus, receives said delivery schedule information data transmitted from said information delivery apparatus, and forwards said delivery schedule information data to said information retrieval control means.

9. An information delivery system according to claim 5, wherein said information retrieval means, if a browser program received by said broadband receiver means has been updated from a browser program stored in said received data storage means, overwrites the browser program stored in said received data storage means with the browser program received by said broadband receiver means.

10. An information delivery system according to claim 5, wherein said receiver apparatus further comprises writing means for writing the program contents and the browser program, stored in said received data storage means, to a predetermined type of information storage medium, said information retrieval control means controlling said writing means so that the program contents and the browser program stored in said received data storage means are written to said predetermined type of information storage medium while maintaining the directory structure of the program contents and the browser program.

11. An information delivery apparatus which for an information delivery system and which automatically delivers information, said information delivery apparatus comprising:
program content storage means for storing the contents of a plurality of programs;
delivery information storage means for storing delivery information corresponding to each of said plurality of programs;
information delivery control means for selecting a program for current delivery from said plurality of programs, and for generating program information data and delivery schedule information data, said program information data including the contents of the selected program and said delivery schedule information data including the delivery information of the selected program;
broadband transmitter means for transmitting said program information data and said delivery schedule information data via a broadband communication path; and
narrowband transmitter means for transmitting said delivery schedule information data via a narrowband communication path.

12. A receiver apparatus for an information delivery system and which receives information, said receiver apparatus comprising:
broadband receiver means for receiving program information data and delivery schedule information data transmitted via a broadband communication path from an information delivery apparatus;
narrowband receiver means for receiving said delivery schedule information data transmitted via a narrowband communication path from said information delivery apparatus;
information retrieval control means for retrieving as desired said program information data received by said broadband receiver means with reference to said delivery schedule information data received by either said broadband receiver means or said narrowband receiver means;
received data storage means for storing the retrieved program information data and said delivery schedule information data; and
display means for displaying, under the control of said information retrieval control means, information in accordance with the retrieved program information data stored in said received data storage means.

13. An information delivery method, in which information is automatically pushed from an information delivery apparatus to a receiver apparatus, said information delivery method comprising the steps of:
said information delivery apparatus:
storing the contents of a plurality of programs and delivery information corresponding to each of said plurality of programs;
transmitting program information data including the contents of one of said plurality of programs, and delivery schedule information data including the delivery information corresponding to the program via a broadband communication path; and
transmitting, as required, said delivery schedule information data via a narrowband communication path;
said receiver apparatus:
receiving said program information data and said delivery schedule information data transmitted via said broadband communication path;
receiving said delivery schedule information data transmitted, as required, via said narrowband communication path;
storing said program information data and said delivery schedule information data; and
displaying information in accordance with said program information data and said delivery schedule information data.

14. An information delivery method according to claim 13, further comprising the steps of:
said receiver apparatus:
reserving at least one program, as selected based on the displayed delivery schedule information data, which is scheduled for subsequent delivery by said information delivery apparatus; and
receiving only said at least one program which has been reserved, and said broadband receiver means receives only said at least one program which has been reserved, transmitted via said broadband communication path.

15. An information delivery method according to claim 14, wherein said delivery information includes the status of the corresponding program as to whether the program is to be transmitted for the first time, and said reserving step does not reserve any program which is not is to be transmitted for the first time.

16. An information delivery method according to claim 14, wherein said reserving step determines priority levels regarding reception of said at least one program which has been reserved.

17. An information delivery method, in which information is automatically pushed from an information delivery apparatus to a receiver apparatus, said information delivery method comprising the steps of:
said information delivery apparatus:
storing, together with the contents of a plurality of programs, at least one browser program for reading the contents of said at least one program; and
transmitting predetermined information data including the contents of one of said at least one program and one of said at least one browser program corresponding to the program via a broadband communication path;
said receiver apparatus:
receiving said predetermined information data including the contents and the browser program, transmitted via said broadband communication path;
storing, in accordance with a predetermined directory structure, the contents, and the browser program if the browser program has been updated; and
displaying the contents using the browser.

18. An information delivery method for delivering product catalog information from an information delivery apparatus to a receiver apparatus, said information delivery method comprising the steps of:
electronically creating at least one product catalog information file of said product catalog information, including motion picture data and sound data;
generating a delivery schedule for delivering said at least one product catalog information file; and
transmitting said at least one product catalog information file and said delivery schedule so that said receiver apparatus is allowed to receive said at least one product catalog information file in accordance with said delivery schedule.

19. An information delivery method for delivering product catalog information from an information delivery apparatus to a receiver apparatus, said information delivery method comprising the steps of:
electronically creating at least one product catalog information file of said product catalog information, including motion picture data and sound data;
generating a delivery schedule for delivering said at least one product catalog information file; and
transmitting said at least one product catalog information file and said delivery schedule so that said receiver apparatus is allowed to play back the motion picture data and sound data included in said at least one product catalog information file in accordance with said delivery schedule.

20. An information delivery method for delivering product catalog information from an information delivery apparatus to a receiver apparatus, said information delivery method comprising the steps of:
electronically creating at least one product catalog information file of said product catalog information;
generating a delivery schedule for delivering said at least one product catalog information file; and
transmitting said at least one product catalog information file and said delivery schedule via a broadband communication path while transmitting said delivery schedule via a narrowband communication path so that said receiver apparatus receives said at least one product catalog information file in accordance with said delivery schedule.
